(19) United States
(12) Patent Application Publication
(10) Pub. No.: US 2026/0169410 A1
(43) Pub. Date: Jun. 18, 2026

(54) IMAGE FORMING APPARATUS, NONVOLATILE STORAGE MEDIUM STORING PROGRAM, AND METHOD OF SETTING LIFE OF PHOTOSENSITIVE BODY IN IMAGE FORMING APPARATUS

(71) Applicant: Yasunari Miyazaki, Sunto Shizuoka (JP)

(72) Inventor: Yasunari Miyazaki, Sunto Shizuoka (JP)

(73) Assignee: ETRIA CO., LTD., Kanagawa (JP)

(21) Appl. No.: 19/286,226

(22) Filed: Jul. 30, 2025

(30) Foreign Application Priority Data
Dec. 18, 2024 (JP) 2024-221793

(51) Int. Cl. G03G 15/00

(52) U.S. Cl. CPC G03G 15/55

(57) ABSTRACT

An image forming apparatus includes a photosensitive body, a developing unit, a storage unit, and a processor. In the photosensitive body, an electrostatic latent image is formed by light applied to a uniformly charged surface. The developing unit develops the electrostatic latent image formed on the photosensitive body. The storage unit stores a life setting value for determining that the photosensitive body has reached a lifespan. The processor corrects the life setting value stored in the storage unit according to an actual residual potential and a standard residual potential in the photosensitive body.

### CROSS REFERENCE TO RELATED APPLICATIONS

This application is based upon and claims the benefit of priority from Japanese Patent Application No. 2024-221793 filed Dec. 18, 2024, the entire contents of which are incorporated herein by reference.

### FIELD

Embodiments described herein relate generally to an image forming apparatus, a nonvolatile storage medium storing a program, and a method of setting a life of a photosensitive body in the image forming apparatus.

### BACKGROUND

Conventionally, an image forming apparatus by an electrophotographic method forms a toner image by developing an electrostatic latent image formed on a photosensitive body with toner. The photosensitive body is cleaned by a cleaner provided with a cleaner blade after the toner image is transferred to a transfer member. In such an image forming apparatus, the cleaning by a cleaner causes deterioration due to, for example, scraping of a photosensitive layer on the photosensitive body. As the deterioration of the photosensitive layer of the photosensitive body progresses, the photosensitive body needs to be replaced in the image forming apparatus.

Some conventional image forming apparatuses determine that the photosensitive body has reached its lifespan (replacement time) if an index value such as the number of passed sheets, a drive distance or a drive time of the photosensitive body reaches a preset set value. However, in an actual image forming apparatus, the deterioration of the photosensitive body does not often proceed as assumed in advance. Therefore, in the image forming apparatus, if the deterioration progresses faster than assumed in advance, the replacement of the photosensitive body that has reached the lifespan may be delayed. In addition, in the image forming apparatus, if the deterioration progresses slower than assumed in advance, there may be a waste of replacing the usable photosensitive body.

### BRIEF DESCRIPTION OF THE DRAWINGS

FIG. 1 is a diagram illustrating a configuration example of an image forming system including a digital multi-functional peripheral as an image forming apparatus according to an embodiment.

FIG. 2 is a diagram illustrating a configuration example of the digital multi-functional peripheral as an image forming apparatus according to the embodiment.

FIG. 3 is a diagram illustrating a configuration example of a printer in the digital multi-functional peripheral as an image forming apparatus according to the embodiment.

FIG. 4 is a block diagram illustrating a configuration example of a control system in the digital multi-functional peripheral as an image forming apparatus according to the embodiment.

FIG. 5A is a graph for describing each potential in an image adjustment operation by the digital multi-functional peripheral as an image forming apparatus according to the embodiment.

FIG. 5B is a graph for describing each potential in an image adjustment operation by the digital multi-functional peripheral as an image forming apparatus according to the embodiment.

FIG. 6 is a graph illustrating an example of a relationship between a residual potential and a deterioration index of a photosensitive drum in the digital multi-functional peripheral as an image forming apparatus according to the embodiment.

FIG. 7 is a graph illustrating an example of transition of an actual residual potential and transition of a standard residual potential in the photosensitive drum by the digital multi-functional peripheral as an image forming apparatus according to the embodiment.

FIG. 8 is a flowchart for describing an operation example including deterioration determination processing in the digital multi-functional peripheral as an image forming apparatus according to the embodiment.

FIG. 9 is a flowchart for describing an example of an operation including life setting value correction processing in the digital multi-functional peripheral as an image forming apparatus according to the embodiment.

FIG. 10 is a graph illustrating an example of a standard lifespan curve and a corrected lifespan curve for the photosensitive drum in the digital multi-functional peripheral as an image forming apparatus according to the embodiment.

FIG. 11 is a flowchart for describing an example of an operation including advance notification processing in the digital multi-functional peripheral as an image forming apparatus according to the embodiment.

### DETAILED DESCRIPTION

According to an embodiment, an image forming apparatus includes a photosensitive body, a developing unit, a storage unit, and a processor. In the photosensitive body, an electrostatic latent image is formed by light applied to a uniformly charged surface. The developing unit develops the electrostatic latent image formed on the photosensitive body. The storage unit stores a life setting value for determining that the photosensitive body has reached a lifespan. The processor corrects the life setting value stored in the storage unit according to an actual residual potential and a standard residual potential in the photosensitive body.

Hereinafter, the present embodiment will be described with reference to the drawings.

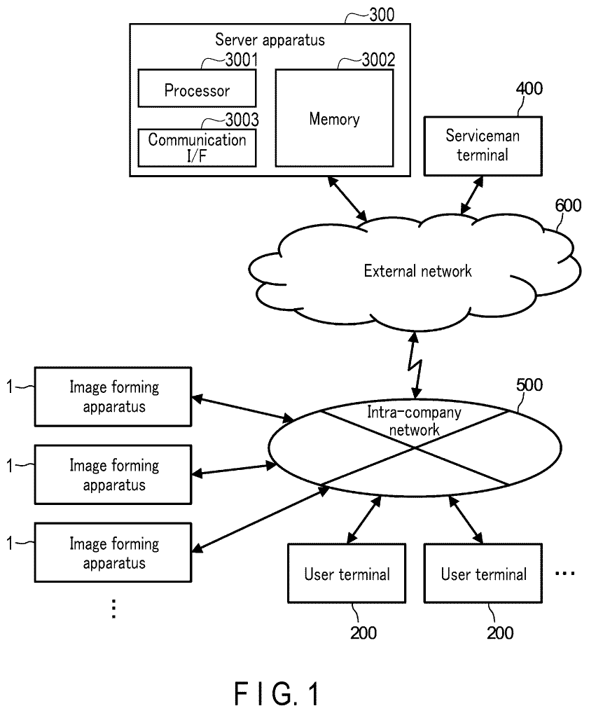

Note that, in each drawing used for the following description of the embodiment, the scale of each part is appropriately changed. Further, in each drawing used for the following description of the embodiment, the configuration is appropriately omitted for the sake of description. FIG. 1 is a schematic configuration diagram of a printing system (image forming system) including a plurality of image forming apparatuses 1 according to the embodiment. The printing system including the image forming apparatus 1 further includes a plurality of user terminals 200, a server apparatus 300, and a serviceman terminal 400.

Each of the image forming apparatuses 1 is placed in a work place and is communicably connected to, for example, the user terminal 200 placed in the same work place via an intra-company network 500 such as a local area network (LAN). This connection may be wired connection or wireless connection. Further, the intra-company network 500 is connected to an external network 600 such as the Internet. The server apparatus 300 and the serviceman terminal 400 are connected to the external network 600. The image forming apparatus 1 is communicably connected to the server apparatus 300 via the intra-company network 500 and the external network 600.

The user terminal 200 is an information processing apparatus that instructs printing in any of the image forming apparatuses 1. The user terminal 200 is, for example, an information processing apparatus such as a personal computer (PC), a smartphone, a tablet terminal, or a digital camera. Note that the user terminal 200 may be communicably connected to the image forming apparatus 1 via the external network 600 and the intra-company network 500. That is, the user terminal 200 may be outside the work place where the image forming apparatus 1 is placed. The user terminal 200 may be directly connected to the image forming apparatus 1 without going through the external network 600 and the intra-company network 500. That is, the user terminal 200 may be locally connected to the image forming apparatus 1. In the case where the user terminal 200 is locally connected to the image forming apparatus 1, the connection may be wired connection or wireless connection.

The server apparatus 300 is a computer apparatus operated directly by a management company that undertakes maintenance and inspection of the image forming apparatus 1 or by outsourcing to a service provider. The server apparatus 300 acquires maintenance information of each image forming apparatus 1 periodically or as necessary. The maintenance information includes information indicating operation status (the number of passed sheets (printing number), drive distance and drive time of a photosensitive drum, size and type of printed sheet, and the like) of the image forming apparatus 1, information indicating a state of each unit, and the like. The server apparatus 300 may acquire notification data such as an alert transmitted from the image forming apparatus 1.

The server apparatus 300 determines necessity of inspection or repair (maintenance) of each image forming apparatus 1 based on the acquired data. In a case where there is the image forming apparatus 1 that requires maintenance, the server apparatus 300 transmits information specifying the image forming apparatus 1 that requires maintenance to the serviceman terminal 400. In a case where notification of the image forming apparatus 1 that requires maintenance is provided by the serviceman terminal 400, a serviceman can proceed to the maintenance of the image forming apparatus 1 according to content notification of which is provided.

The server apparatus 300 is an information processing apparatus including a processor 3001, a memory 3002, a communication interface (I/F) 3003, and the like. The processor 3001 is, for example, a CPU. The processor 3001 executes various types of processing by executing a program stored in the memory 3002. The communication interface 3003 is an interface for communicating with each apparatus via the network 600. The memory 3002 includes a storage such as a ROM, a RAM, and a nonvolatile memory. The memory 3002 includes a program memory that stores a program, a working memory that temporarily holds data, and a data memory that accumulates data.

In the server apparatus 300, the memory 3002 has a storage area that stores a database that stores maintenance information acquired from the image forming apparatus 1 and the like. The processor 3001 of the server apparatus 300 stores information such as the maintenance information acquired from the image forming apparatus 1 in the database of the memory 3002. The processor 3001 of the server apparatus 300 determines the necessity of maintenance for each image forming apparatus based on the maintenance information of each image forming apparatus stored in the database.

The serviceman terminal 400 is an information processing apparatus such as a smartphone or a tablet terminal carried by the serviceman who performs the maintenance of the image forming apparatus 1. Although only one service person terminal 400 is illustrated in FIG. 1, the printing system may include a plurality of the serviceman terminals 400. The serviceman terminal 400 may have a position detection function and transmit a position detected by the position detection function to the server apparatus 300 as position information of the serviceman. The server apparatus 300 can also assign an appropriate serviceman to the image forming apparatus 1 that requires maintenance based on information such as the position information of each serviceman and an availability of each serviceman.

Next, a configuration of a digital multi-functional peripheral (MFP) as an example of the image forming apparatus 1 according to the embodiment will be described.

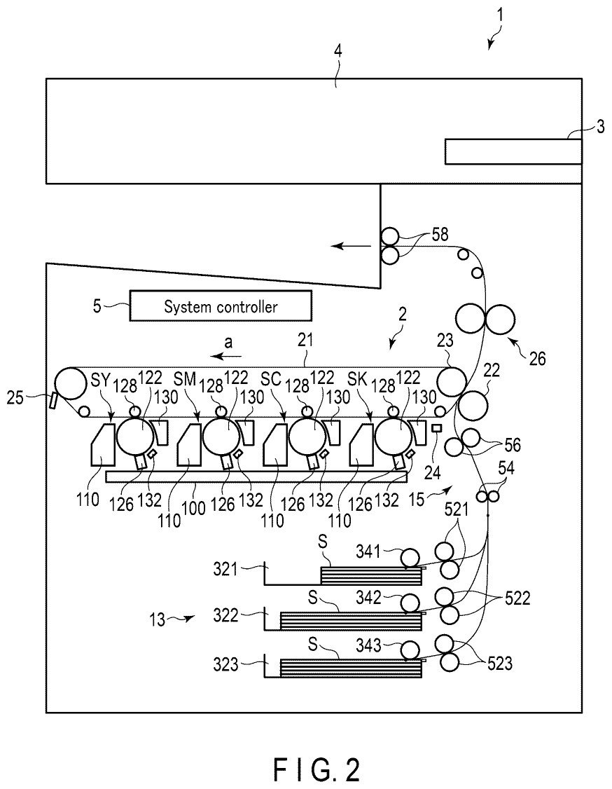

FIG. 2 is a block diagram illustrating a configuration example of a digital multi-functional peripheral as an example of the image forming apparatus 1 according to the embodiment.

As illustrated in FIG. 2, the digital multi-functional peripheral as the image forming apparatus 1 includes a printer 2, an operation panel 3, a scanner 4, a system controller 5, and the like.

The printer 2 is an image forming apparatus that forms an image on a recording medium. In the present embodiment, the printer 2 forms an image on a recording medium by an electrophotographic method. The printer 2 by an electrophotographic method forms an image (toner image) on a recording medium such as paper with toner. The recording medium on which the printer 2 forms an image may be any medium on which an image can be formed, and is not limited to a paper, and may be cloth, a plastic film, a sheet, or the like.

The scanner 4 is installed on an upper part of a main body of the digital multi-functional peripheral. The scanner 4 is an apparatus that optically reads an image of a document. For example, the scanner 4 reads an image of a document set on a document table glass. Further, the scanner 4 may be configured to read an image of a document conveyed by an auto document feeder (ADF).

The operation panel 3 is a user interface. The operation panel 3 includes a display unit (display), a touch panel, an operation button, and the like. The operation panel 3 displays an operation guide and the like on the display unit. The operation panel 3 receives an operation instruction from a user through the touch panel, the operation button, and the like. For example, the operation panel 3 is provided with a touch panel on a display screen of the display unit, and detects a portion touched by the user on the display screen of the display unit.

The system controller 5 controls the entire digital multi-functional peripheral including the image forming apparatus 1. The system controller 5 controls the operation of each unit in response to the operation instruction input to the operation panel 3. In addition, the system controller 5 receives an operation instruction from an external apparatus connected via an interface and controls the operation of each unit. For example, in a case where image formation on a recording medium is instructed, the system controller 5 controls the printer 2 to cause the printer 2 to execute the image formation on the recording medium.

Hereinafter, the configuration of the printer 2 will be described.

As illustrated in FIG. 2, the printer 2 includes a medium supply mechanism 13, a conveyance mechanism 15, a plurality of image forming stations SY, SM, SC, and SK, an intermediate transfer belt (transfer belt) 21, a secondary transfer roller 22, a support roller 23, a toner sensor 24, a transfer belt cleaner 25, a fixing unit 26, and the like.

The medium supply mechanism 13 includes a plurality of sheet feed cassettes 321, 322, and 323. The number of sheet feed cassettes may be any number. Each of the sheet feed cassettes 321, 322, and 323 stores a sheet as a recording medium S. The sheet as the recording medium S stored in each sheet feed cassette may store sheets of different sizes or different types. Pickup rollers 341, 342, and 343 are arranged in the sheet feed cassettes 321, 322, and 323, respectively. Each of the pickup rollers 341, 342, and 343 takes out a sheet as a recording medium sheet by sheet from the sheet feed cassette 321, 322, or 323. Each of the pickup rollers 341, 342, and 343 supplies the taken-out recording medium S to the conveyance mechanism 15.

The conveyance mechanism 15 conveys the recording medium S. The conveyance mechanism 15 includes first conveyance rollers 521, 522, and 523, a second conveyance roller 54, and a registration roller 56 on a conveyance path before an image is formed on the recording medium S. The conveyance mechanism 15 conveys the recording medium S supplied by the pickup roller 341, 342, or 343 from the first conveyance roller 521, 522, or 523 to the second conveyance roller 54. In the conveyance mechanism 15, the second conveyance roller 54 further conveys the recording medium S to the registration roller 56.

The registration roller 56 of the conveyance mechanism 15 conveys the recording medium S to a secondary transfer position according to timing of transferring the image from the intermediate transfer belt 21 to the recording medium S at the secondary transfer position to be described below. The conveyance mechanism 15 forms a conveyance path so as to convey the recording medium S to which the image has been transferred from the intermediate transfer belt 21 to the fixing unit 26. Further, the conveyance mechanism 15 includes a third conveyance roller 58 for ejecting the sheet to a sheet ejector, a conveyance mechanism for conveying the recording medium S to a reversing unit for reversing the recording medium S, and the like.

Each of the image forming stations SY, SM, SC, and SK forms an image with toner. In the present embodiment, the image forming station SY forms a yellow image. The image forming station SM forms a magenta image. The image forming station SC forms a cyan image. It is assumed that the image forming station SK forms a black image. Each of the image forming stations SY, SM, SC, and SK transfers the image formed with toner to the intermediate transfer belt 21. The configuration of each of the image forming stations SY, SM, SC, and SK will be described in detail below.

The intermediate transfer belt 21 is a medium (image carrier) that holds the image to be transferred by each of the image forming stations SY, SM, SC, and SK. The intermediate transfer belt 21 is an endless belt as illustrated in FIG. 2. The intermediate transfer belt 21 moves in a direction indicated by the arrow a in FIG. 2. The intermediate transfer belt 21 moves the image transferred by each of the image forming stations SY, SM, SC, and SK to a position where the secondary transfer roller 22 and the support roller 23 face each other.

The secondary transfer roller 22 and the support roller 23 constitute a transfer unit (secondary transfer unit) that transfers the image from the intermediate transfer belt 21 to the recording medium. The position where the secondary transfer roller 22 and the support roller 23 face each other is the secondary transfer position where the image is transferred from the intermediate transfer belt 21 to the recording medium. The secondary transfer roller 22 and the support roller 23 sandwich the intermediate transfer belt 21 and the recording medium at the secondary transfer position.

The support roller 23 supports the intermediate transfer belt 21. The support roller 23 is a drive roller that drives the intermediate transfer belt 21. The secondary transfer roller 22 faces the support roller 23 across the intermediate transfer belt 21. The secondary transfer roller 22 transfers (secondarily transfers) the image formed with toner on a transfer surface of the intermediate transfer belt 21 onto a surface of the recording medium.

The toner sensor 24 is a sensor that detects a toner amount (density). The toner sensor 24 detects a toner adhesion amount on the intermediate transfer belt 21. The toner sensor 24 is arranged to face the transfer surface of the intermediate transfer belt 21. The toner sensor 24 is provided between an image transfer position (primary transfer position) by each image forming station and the secondary transfer position in the moving direction a of the intermediate transfer belt 21. The toner sensor 24 outputs the detected toner adhesion amount to the system controller 5.

As illustrated in FIG. 2, the transfer belt cleaner 25 is arranged between the secondary transfer position and the primary transfer position in the moving direction a of the intermediate transfer belt 21. The transfer belt cleaner 25 removes the toner on the intermediate transfer belt 21. For example, the transfer belt cleaner 25 removes the residual toner on the transfer surface of the intermediate transfer belt 21 after the image is transferred from the intermediate transfer belt 21 to the recording medium.

The fixing unit 26 fixes the image formed with the toner transferred to the recording medium to the recording medium. The fixing unit 26 is arranged on the conveyance path of the recording medium after passing through the secondary transfer position. The fixing unit 26 includes a pressure roller and a heating roller facing each other. The fixing unit 26 applies heat and pressure to the recording medium by conveying the recording medium between the heating roller and the pressure roller facing each other. The fixing unit 26 fixes the toner image transferred to the recording medium by heating the recording medium in a pressurized state.

Next, the configuration of each of the image forming stations SY, SM, SC, and SK of the printer 2 in the digital multi-functional peripheral as the image forming apparatus 1 according to the embodiment will be described in detail.

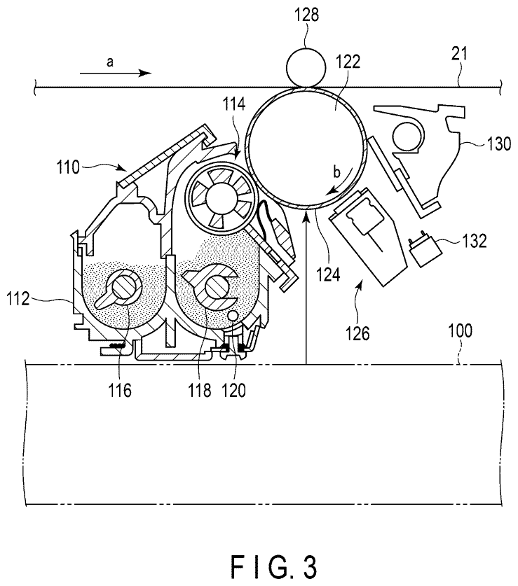

FIG. 3 is a diagram illustrating a configuration example of each of the image forming stations SY, SM, SC, and SK in the printer 2.

As illustrated in FIG. 3, each of the image forming stations SY, SM, SC, and SK includes an exposure unit 100, a developing unit 110, a photosensitive drum 122, a charger 126, a primary transfer roller 128, a photosensitive cleaner 130, a static eliminator 132, and the like. In the present embodiment, each of the image forming stations SY, SM, SC, and SK has the configuration as illustrated in FIG. 3.

The photosensitive drum 122 is an image carrier provided with a photosensitive layer 124 on a surface thereof. The photosensitive drum 122 rotates in a direction (a direction indicated by the arrow b in FIG. 3) in accordance with the movement of the intermediate transfer belt 21 in the moving direction a. The charger 126, the exposure unit 100, the developing unit 110, the primary transfer roller 128, the intermediate transfer belt 21, the photosensitive cleaner 130, and the static eliminator 132 are arranged around the photosensitive drum 122.

The charger 126 uniformly charges the photosensitive layer 124 on the surface of the photosensitive drum 122. The charger 126 uniformly charges the photosensitive layer 124 on the surface of the photosensitive drum 122 to negative polarity, for example. In the present embodiment, the charger 126 charges the photosensitive layer 124 of the photosensitive drum 122 to a charging potential Vo in accordance with a control instruction from the controller 5.

The exposure unit 100 forms a pattern of static electricity (electrostatic latent image) according to the image on the surface of the photosensitive drum 122. The exposure unit 100 irradiates the surface of the photosensitive drum 122 with light of which light emission is controlled based on image data. For example, the exposure unit 100 irradiates the surface of the photosensitive drum 122 with light emitted based on image data via an optical system such as a polygon mirror. The exposure unit 100 may include an apparatus that emits a plurality of laser beams guided to the photosensitive drums 122 of the plurality of image forming stations. Further, the exposure unit 100 may be a light emitting apparatus provided for each of the plurality of image forming stations.

The developing unit 110 develops the electrostatic latent image formed on the surface of the photosensitive drum 122 with a developer. The developing unit 110 supplies the developer to the surface of the photosensitive drum 122 exposed by the exposure unit 100. The developing unit 110 of each of the image forming stations develops the image in a corresponding color. For example, the developing unit 110 in the image forming station SY develops the electrostatic latent image on the photosensitive drum 122 with yellow toner. The developing unit 110 of the image forming station SM develops the electrostatic latent image on the photosensitive drum 122 with magenta toner. The developing unit 110 in the image forming station SC develops the electrostatic latent image on the photosensitive drum 122 with cyan toner. The developing unit 110 of the image forming station SK develops the electrostatic latent image on the photosensitive drum 122 with black toner.

In the configuration example illustrated in FIG. 3, the developing unit 110 includes a developer container 112, a developing roller 114, a first mixer 116, a second mixer 118, and a toner density sensor 120. The developer container 112 is a container that stores the developer. The developer is a mixture of the carrier including magnetic fine particles and the toner. In a case where the developer is stirred, the toner is triboelectrically charged. As a result, the toner adheres to the surface of the carrier by electrostatic force.

The developing roller 114, the first mixer 116, the second mixer 118, and the toner density sensor 120 are arranged inside the developer container 112.

The toner density sensor 120 is arranged inside the developer container 112. The toner density sensor 120 detects toner density in the developer stored in the developer container 112. The toner density is represented by, for example, a ratio (toner/carrier) between the toner and the carrier of the developer in the developer container 112. The system controller 5 performs control such that the toner density detected by the toner density sensor 120 becomes a predetermined value.

The developing roller 114 contains, for example, a magnetic material (for example, a magnet) in which a positive electrode and a negative electrode are alternately arranged along a circumferential manner. The developing roller 114 rotates counterclockwise. The first mixer 116 and the second mixer 118 stir the developer in the developer container 112. The first mixer 116 and the second mixer 118 convey the developer. The second mixer 118 arranged below the developing roller 114 supplies the developer to the surface of the developing roller 114.

The developer adheres to the surface of the developing roller 114 in a napped state according to a magnetic field distribution generated by the magnetic material of the developing roller 114. The developing roller 114 rotates in a state of carrying the developer. The layer of the developer adhering to the developing roller 114 is limited to a predetermined thickness by a blade provided so that the distance from the surface of the developing roller 114 is a predetermined width. Regarding the developer carried by the developing roller 114, the developer limited to the predetermined thickness by the blade and carried by the developing roller 114 moves to a position (developing position) facing the surface of the photosensitive drum 122.

A developing bias is applied to the developing roller 114 that carries the developer. A potential (development potential) of the surface of the developing roller 114 is controlled by the developing bias. The toner in the developer carried by the developing roller 114 adheres to the electrostatic latent image by a potential difference (contrast voltage) between the potential of the surface of the developing roller 114 and the potential of the electrostatic latent image formed on the surface of the photosensitive drum 122. In a case where the developing roller 114 rotates in a predetermined direction, the developer carried by the developing roller 114 approaches the surface of the photosensitive drum 122 on which the electrostatic latent image is formed. The toner contained in the developer carried by the developing roller 114 develops the electrostatic latent image on the photosensitive drum 122 in a case where the toner approaches the surface of the photosensitive drum 122. As a result, the toner image obtained by developing the electrostatic latent image with toner is formed on the photosensitive drum 122.

Here, the potential difference between the potential (development potential Vd) of the surface of the developing roller 114 and the potential (residual potential Ver) of the electrostatic latent image formed on the surface of the photosensitive drum 122 is referred to as a contrast voltage Vc. The contrast voltage is related to the density of the toner moving from the developing roller 114 to the electrostatic latent image on the photosensitive drum 122. The density of the toner image formed on the photosensitive drum 122 is adjusted by controlling the contrast voltage Vc. In a case where the contrast voltage Vc is adjusted, the development potential Vd and the charging potential Vo are adjusted.

The image (toner image) developed with the toner on the surface of the photosensitive drum 122 moves to a position corresponding to the primary transfer roller 128 by the rotation of the photosensitive drum 122. The primary transfer roller 128 faces the photosensitive drum 122 across the intermediate transfer belt 21. The primary transfer roller 128 comes in contact with the surface of the photosensitive drum 122 with the intermediate transfer belt 21 interposed therebetween. The primary transfer roller 128 transfers the toner image on the surface of the photosensitive drum 122 to the intermediate transfer belt 21 (primary transfer).

The photosensitive cleaner 130 is arranged downstream of the position where the toner image on the surface of the photosensitive drum 122 is transferred onto the intermediate transfer belt 21 in a circumferential direction of the photosensitive drum 122. The photosensitive cleaner 130 removes the toner on the surface of the photosensitive drum 122. That is, the photosensitive cleaner 130 removes the toner remaining on the surface of the photosensitive drum 122 after executing the primary transfer of the toner image from the photosensitive drum 122 to the intermediate transfer belt 21. The photosensitive cleaner 130 includes, for example, a cleaning blade that is in close contact with the surface of the photosensitive drum 122. The photosensitive cleaner 130 removes the toner from the surface of the photosensitive drum 122 on which the cleaning blade rotates.

The static eliminator 132 is arranged downstream of the position of the photosensitive cleaner 130 in the circumferential direction of the photosensitive drum 122. The static eliminator 132 irradiates the surface of the photosensitive drum 122 with light. As a result, the static eliminator 132 removes a charge remaining on the photosensitive layer 124 on the surface of the photosensitive drum 122.

Next, a configuration of the control system in the digital multi-functional peripheral 1 as the image forming apparatus according to the embodiment will be described.

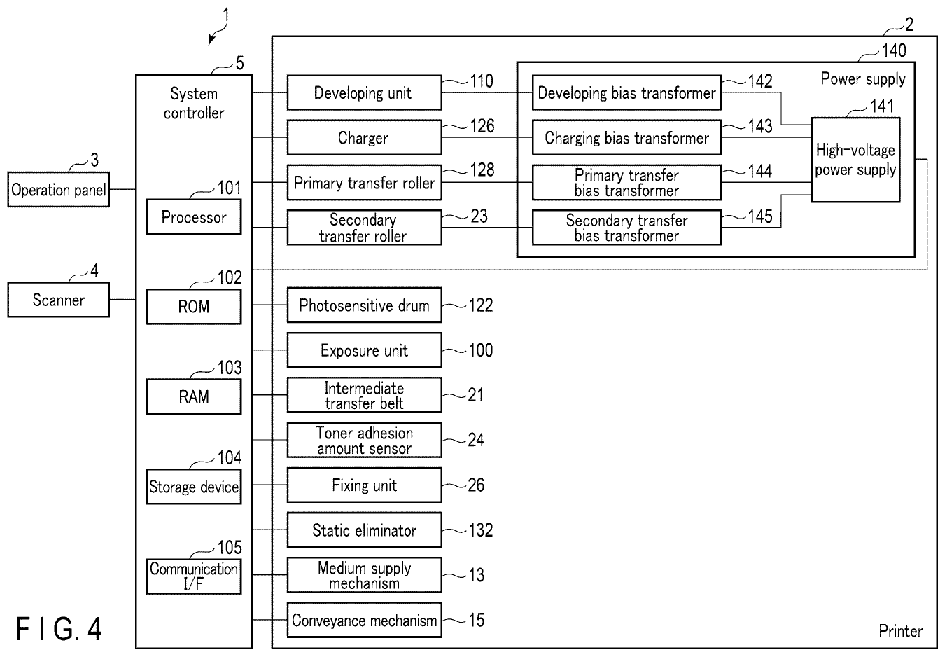

FIG. 4 is a block diagram illustrating a configuration example of the control system in the digital multi-functional peripheral 1 as the image forming apparatus according to the embodiment.

As illustrated in FIG. 4, the system controller 5 includes a processor 101, a ROM 102, a RAM 103, a storage (storage unit) 104, a communication interface (I/F) 105, and the like. In addition, the processor 101 of the system controller 5 is connected to each unit in the digital multi-functional peripheral 1 via various interfaces.

The processor 101 implements various types of processing by executing a program. The processor 101 is, for example, a CPU. The processor 101 is connected to the ROM 102, the RAM 103, the storage 104, a communication interface (I/F) 105, and the like. In addition, the processor 101 is connected to each unit in the printer 2, the operation panel 3, and the scanner 4 via an interface.

The ROM 102 is a nonrewritable nonvolatile memory. The ROM 102 operates as a program memory that stores a program. The RAM 103 operates as a working memory or a buffer memory. The processor 101 executes various types of processing by executing the program stored in the ROM 102 or the storage 104 using the RAM 103.

The storage 104 is a rewritable nonvolatile memory. For example, the storage 104 includes a storage such as a hard disk drive (HDD) or a solid state drive (SSD). The storage 104 stores data such as control data, a control program, setting information, image data, and print job data. In the embodiment, the storage 104 is an example of a storage unit that stores a life setting value to be described below. Furthermore, the storage 104 is an example of a storage unit that stores a notification setting value to be described below. Furthermore, the storage 104 also stores a photosensitive body table and the like to be described below.

The communication I/F 105 is an interface for performing data communication with an external apparatus. For example, the communication I/F 105 communicates with the user terminal such as a PC or a mobile terminal via a network. The communication I/F 105 may receive an image print request (print job) or the like from the user terminal such as a PC.

As illustrated in FIG. 4, the printer 2 includes a power supply 140 in addition to the configurations illustrated in FIGS. 1 and 3.

The power supply 140 supplies voltages to the developing unit 110, the charger 126, the primary transfer roller 128, and the secondary transfer roller 22. In the configuration example illustrated in FIG. 4, the power supply 140 includes a high-voltage power supply 141, a developing bias transformer 142, a charging bias transformer 143, a primary transfer bias transformer 144, and a secondary transfer bias transformer 145. The developing bias transformer 142, the charging bias transformer 143, and the primary transfer bias transformer 144 are provided for each of the image forming stations SY, SM, SC, and SK.

The high-voltage power supply 141 supplies a high voltage to the transformers 142, 143, 144, and 145. The high voltage is, for example, a voltage of several hundreds V to several kV. The high-voltage power supply 141 generates the high voltage from an input voltage of several tens V, for example.

The developing bias transformer 142 supplies the development potential to the developing unit 110. The developing bias transformer 142 converts the high voltage generated by the high-voltage power supply 141 into a developing bias voltage having a voltage value set by the system controller 5. The developing bias transformer 142 supplies the developing bias voltage specified by the system controller 5 to the developing unit 110. As a result, in the developing unit 110, the development potential Vd is controlled by the system controller 5.

The charging bias transformer 143 supplies a charging bias voltage to the charger 126. The charging bias transformer 143 converts the high voltage generated by the high-voltage power supply 141 into the charging bias voltage having a voltage value set by the system controller 5. The charging bias transformer 143 supplies the charging bias voltage specified by the system controller 5 to the charger 126. As a result, the charger 126 charges the photosensitive layer 124 on the surface of the photosensitive drum 122 to a charging potential Vo corresponding to the charging bias voltage specified by the system controller 5.

The primary transfer bias transformer 144 supplies a primary transfer bias voltage to the primary transfer roller 128. The primary transfer bias transformer 144 converts the high voltage generated by the high-voltage power supply 141 into the primary transfer bias voltage having a voltage value set by the system controller 5. The primary transfer bias transformer 144 supplies the primary transfer bias voltage specified by the system controller 5 to the primary transfer roller 128.

The secondary transfer bias transformer 145 supplies a secondary transfer bias voltage to the secondary transfer roller 22. The secondary transfer bias transformer 145 converts the high voltage generated by the high-voltage power supply 141 into the secondary transfer bias voltage having a voltage value set by the system controller 5. The secondary transfer bias transformer 145 supplies the secondary transfer bias voltage specified by the system controller 5 to the secondary transfer roller 22.

Next, an operation of image forming processing in the printer 2 as the image forming apparatus according to the embodiment will be described.

The digital multi-functional peripheral 1 acquires an image to be formed on a recording medium M, and executes image forming processing of printing the acquired image on the recording medium M by the printer 2. For example, in a case where copy is instructed on the operation panel 3, the processor 101 of the system controller 5 executes processing of printing an image of a document read by the scanner 4 on the recording medium M by the printer 2.

In a case of executing the image forming processing, the processor 101 of the system controller 5 takes in the recording medium M stored in the container by the medium supply mechanism 13. The processor 101 causes the conveyance mechanism 15 to convey the recording medium M supplied from the medium supply mechanism 13 to a position in front of the registration roller 56 in the printer 2.

In addition, the processor 101 of the system controller 5 generates the image to be formed by each of the image forming stations SY, SM, SC, and SK based on the image (print image) to be printed on the recording medium M. For example, the processor 101 generates the image of each color (yellow, magenta, cyan, or black) to be formed by each of the image forming stations SY, SM, SC, and SK from the print image. In a case where the processor 101 has generated the image of each color from the print image, the processor 101 causes each image forming station to form the generated image of each color.

In each of the image forming stations SY, SM, SC, and SK, the charger 126 receives the charging bias voltage from the charging bias transformer 143 to charge the photosensitive layer 124 of the photosensitive drum 122. The exposure unit 100 irradiates the photosensitive drum 122 of each of the image forming stations SY, SM, SC, and SK with light for forming the electrostatic latent image corresponding to the image of each color. In each of the image forming stations SY, SM, SC, and SK, the electrostatic latent image is formed on the photosensitive layer 124 of the photosensitive drum 122 by the light emitted from the exposure unit 100.

Each of the image forming stations SY, SM, SC, and SK develops the electrostatic latent image on the photosensitive drum 122 with the toner of the color stored in the developing unit 110. In each of the image forming stations SY, SM, SC, and SK, the developing roller 114 rotates while carrying the developer including the toner of each color supplied from the developer container 112. The developing bias voltage from the developing bias transformer 142 is applied to the developing roller 114 that carries the developer. The developing unit 110 supplies the toner in the developer carried by the developing roller 114 to the electrostatic latent image by the potential difference (contrast voltage) between the potential on the developing roller 114 and the electrostatic latent image on the photosensitive drum 122.

In each of the image forming stations SY, SM, SC, and SK, the photosensitive drum 122 moves the image (toner image) developed by the developing unit 110 to the position (primary transfer position) facing the primary transfer roller 128. At the primary transfer position, the photosensitive drum 122 faces the primary transfer roller 128 across the intermediate transfer belt 21. The primary transfer bias voltage from the primary transfer bias transformer 144 is applied to the primary transfer roller 128. The toner image on the photosensitive drum 122 is transferred to the intermediate transfer belt 21 by the primary transfer roller to which the primary transfer bias voltage is applied at the primary transfer position. In a case of forming a color image, each of the image forming stations SY, SM, SC, and SK transfers the toner image of each color in a superimposed manner on the intermediate transfer belt 21. As a result, the color image in which the toner images of the respective colors are superimposed is transferred onto the intermediate transfer belt 21.

The intermediate transfer belt 21 moves the transferred toner image to the position (secondary transfer position) facing the secondary transfer roller 22. As for the recording medium M, the registration roller 56 feeds the recording medium M to the secondary transfer position in synchronization with the position and timing of the image transferred onto the intermediate transfer belt 21. As a result, the secondary transfer roller 22 and the support roller 23 convey the intermediate transfer belt 21 and the recording medium M in an overlapping state at the secondary transfer position. The secondary transfer bias voltage from the secondary transfer bias transformer 145 is applied to the secondary transfer roller 22. The toner image on the intermediate transfer belt 21 is transferred to the recording medium M by the secondary transfer roller 22 to which the secondary transfer bias voltage is applied at the secondary transfer position.

The recording medium M that has passed through the secondary transfer position is conveyed to the fixing unit 26. The fixing unit 26 fixes the toner image transferred from the intermediate transfer belt 21 to the recording medium M at the secondary transfer position to the recording medium M. The fixing unit 26 applies heat and pressure to the recording medium M to which the toner image has been transferred to fix the toner image on the recording medium M. The recording medium M having passed through the fixing unit 26 is ejected from the sheet ejector in the state where the toner image is fixed.

Next, the lifespan (replacement time) of the photosensitive drum 122 in the printer 2 of the digital multi-functional peripheral as the image forming apparatus 1 according to the embodiment will be described.

As described above, the photosensitive drum 122 includes the photosensitive layer 124 on the surface. The surface of the photosensitive drum 122 is cleaned by the cleaner blade of the photosensitive cleaner after the toner image is transferred to the transfer member. Since the photosensitive drum 122 rotates with the cleaning blade in contact with the surface, a film of the photosensitive layer 124 on the surface is scraped. The film scraping of the photosensitive layer 124 is a main cause of deterioration of the photosensitive drum 122. As the film scraping of the photosensitive layer 124 progresses, the residual potential in the photosensitive layer 124 of the photosensitive drum 122 increases.

The lifespan (replacement time) of the photosensitive drum 122 is set according to a degree of deterioration of the photosensitive drum 122 due to, for example, the film scraping of the photosensitive layer 124. In general, as an index (a deterioration index or a life index) for determining the lifespan due to deterioration of the photosensitive drum 122, the number of passed sheets (printing number), the drive distance or the drive time of the photosensitive drum, or the like is used. In a case where a specific deterioration index reaches the life setting value, the image forming apparatus 1 determines that the photosensitive drum 122 has reached the lifespan (replacement time).

The film scraping of the photosensitive layer 124, which causes the deterioration of the photosensitive drum 122, is affected by an environment. Therefore, the preset fixed life setting value (the initial value of the life setting value) is not necessarily suitable for determining the actual lifespan of the photosensitive drum 122. For example, in a case of a low temperature environment, the cleaning blade that is in pressure contact with the surface of the photosensitive drum 122 becomes hard, which may promote the film scraping of the photosensitive layer 124. In the case where the film scraping of the photosensitive layer 124 is promoted, it is necessary to replace the photosensitive drum 122 early before the specific deterioration index reaches the fixed life setting value in order to maintain predetermined image quality. That is, since a degree of progress of the deterioration of the photosensitive drum 122 varies depending on an actual use environment, it is necessary to determine the lifespan according to an actual state.

The image forming apparatus 1 according to the present embodiment corrects (updates) the life setting value for the deterioration index according to the degree of progress of the deterioration of the photosensitive drum 122. In addition, the image forming apparatus 1 calculates the degree of progress of the deterioration of the photosensitive drum 122 according to the residual potential in the photosensitive layer 124 on the surface of the photosensitive drum 122. The residual potential of the photosensitive drum 122 may be measured by providing a potential sensor, or may be calculated by an image adjustment operation (image quality maintenance control). In the present embodiment, description will be given on the assumption that the image forming apparatus 1 calculates the current residual potential (actual residual potential) of the photosensitive layer 124 of the photosensitive drum 122 by the image adjustment operation.

The image adjustment operation in the image forming apparatus 1 is processing of adjusting the density of the image to be formed on (transferred to) the recording medium M. The density of the image to be formed on the recording medium M changes depending on the amount (density) of the toner supplied from the developing roller 114 to the electrostatic latent image in a case where the electrostatic latent image on the photosensitive drum 122 is developed. That is, the image adjustment operation by the image forming apparatus 1 is processing of adjusting the toner amount to be supplied to the electrostatic latent image. In the image adjustment operation, the toner density is adjusted by adjusting the contrast voltage.

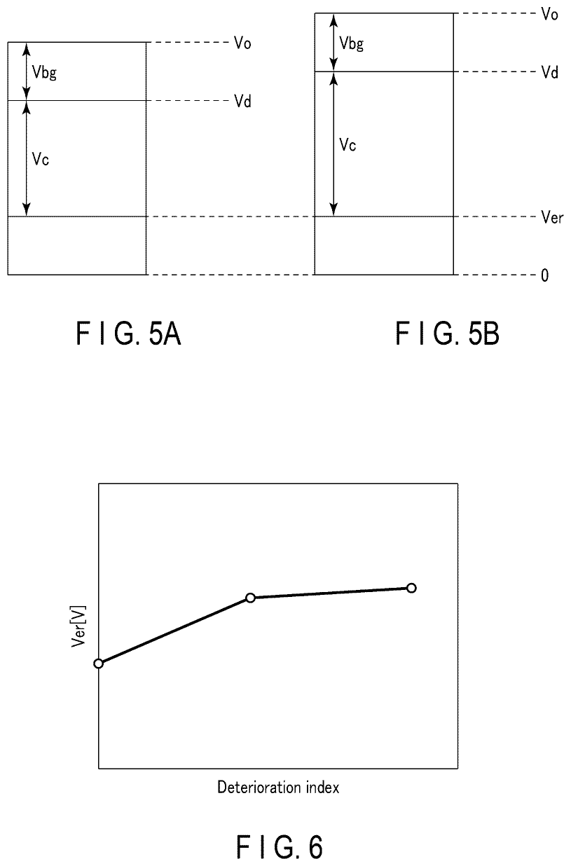

FIGS. 5A and 5B are graphs illustrating relationships between potentials in the image adjustment operation by the image forming apparatus 1.

In the examples illustrated in FIGS. 5A and 5B, the relationship among the charging potential Vo, the residual potential Ver, the development potential Vd, the contrast voltage Vc, and a background voltage Vbg is illustrated.

The charging potential Vo is a surface potential of the photosensitive drum 122 charged by the charger 126. The residual potential Ver is a potential of a portion of the electrostatic latent image irradiated with light from the exposure unit 100 on the surface of the photosensitive drum 122. The development potential Vd is a potential at which the developing unit 110 supplies the toner to the electrostatic latent image on the photosensitive drum 122. The contrast voltage Vc is a potential difference between the development potential Vd and the residual potential Ver. The background voltage Vbg is a potential difference between the charging potential Vo and the development potential Vd.

The density (image density) of the toner is adjusted according to the contrast voltage Vc that is the potential difference between the residual potential Ver that is the potential of the electrostatic latent image on the photosensitive drum 122 and the development potential Vd. The image forming apparatus 1 executes the image adjustment operation (image quality maintenance control) in order to adjust the density of the image of each color formed by each image forming station. The image forming apparatus 1 may perform the image adjustment operation for adjusting the density of the toner at predetermined timing (on a predetermined cycle) or at arbitrary timing.

The image forming apparatus 1 adjusts the density of the image of each color to be formed on the recording medium M by controlling the contrast voltage Vc for each image forming station of each color. In the image adjustment operation, the image forming apparatus 1 adjusts the contrast voltage Vc in each image forming station, and calculates the current residual potential Ver based on the contrast voltage Vc. In addition, the image forming apparatus 1 also adjusts the background voltage Vbg according to the adjustment of the contrast voltage Vc so as not to cause toner covering or the like.

For example, in the image adjustment operation, the image forming apparatus 1 determines the density of the image (toner image) formed by each of the image forming stations SY, SM, SC, and SK detected by the toner sensor 24. In a case of determining that the density of a certain image is low, the image forming apparatus 1 increases the contrast voltage Vc at the image forming station that has formed the image, as illustrated in FIG. 5B. In the case of increasing the contrast voltage Vc, the image forming apparatus 1 also adjusts the background voltage Vbg by increasing the charging potential Vo, as illustrated in FIG. 5B. As a result, the image forming apparatus 1 adjusts the density of the image formed by each image forming station to fall within a predetermined range.

Next, a relationship between the deterioration index as an index indicating the deterioration of the photosensitive drum 122 and the residual potential Ver of the photosensitive drum 122 in the image forming apparatus 1 will be described.

FIG. 6 is a graph illustrating an example of the residual potential Ver of the photosensitive drum 122 with respect to the deterioration index in the image forming apparatus 1.

Here, the deterioration index is the number of passed sheets (printing number), the drive distance of the photosensitive drum, the drive time of the photosensitive drum, and the like. FIG. 6 illustrates that the residual potential Ver increases as the number of passed sheets, the drive distance, or the drive time as the deterioration index increases. In a case where the residual potential Ver has reached a predetermined threshold value (limit value) VT, it is determined that the photosensitive drum 122 is at the lifespan (replacement time). The setting value (life setting value) for determining the lifespan of the photosensitive drum 122 is set for the deterioration index. For example, in a case where the life setting value is set based on the graph illustrated in FIG. 6, the deterioration index at which the residual potential Ver becomes the limit value VT is set as the life setting value.

Next, transition of the residual potential (residual current value) Ver with respect to the deterioration index of the photosensitive drum 122 in the image forming apparatus 1 will be described.

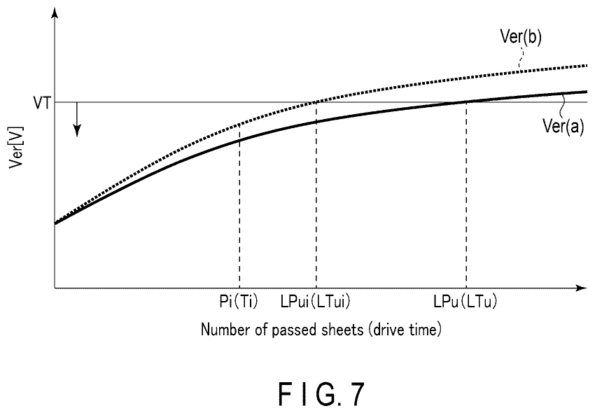

FIG. 7 is a graph illustrating an example of transition of the residual potential Ver with respect to the deterioration index of the photosensitive drum 122 in the image forming apparatus 1.

In the example illustrated in FIG. 7, the transition of the residual potential (hereinafter also referred to as the standard residual potential) Ver(a) set (assumed) in advance is illustrated with the solid line, and the transition of the residual potential (hereinafter also referred to as the actual residual potential) Ver(b) actually calculated (or measured) is illustrated with the dotted line. For example, the standard residual potential Ver(a) is calculated according to a photosensitive body table that stores the residual potentials set in advance in consideration of environmental conditions. The actual residual potential Ver(b) is calculated as an effective value by the image adjustment operation. Note that the actual residual potential Ver(b) only needs to be the actual residual potential of the photosensitive drum 122, or may be a value actually measured by a potential sensor or the like.

FIG. 7 illustrates a case where the actual residual potential Ver(b) is larger than the standard residual potential Ver(a) with respect to a certain deterioration index. This indicates that actual deterioration of the photosensitive drum 122 progresses faster than preset deterioration (standard deterioration). In the transition of the standard residual potential, the lifespan (standard lifespan) ends if the residual potential Ver(a) reaches a predetermined limit value VT. In contrast, in the transition of the actual residual potential, the lifespan (predicted lifespan) ends earlier than the standard lifespan if the residual potential Ver(b) reaches the predetermined limit value VT.

Further, assuming that the deterioration index is the number of passed sheets P, the actual residual potential Ver(bPi) in a case where the number of passed sheets is Pi is larger than the standard residual potential Ver(aPi). Further, assuming that the deterioration index is the drive time Ti of the photosensitive drum 122, the actual residual potential Ver(bTi) in a case where the drive time is Ti is larger than the standard residual potential Ver(aTi).

Next, deterioration determination processing of the photosensitive drum 122 in the image forming apparatus 1 according to the embodiment will be described.

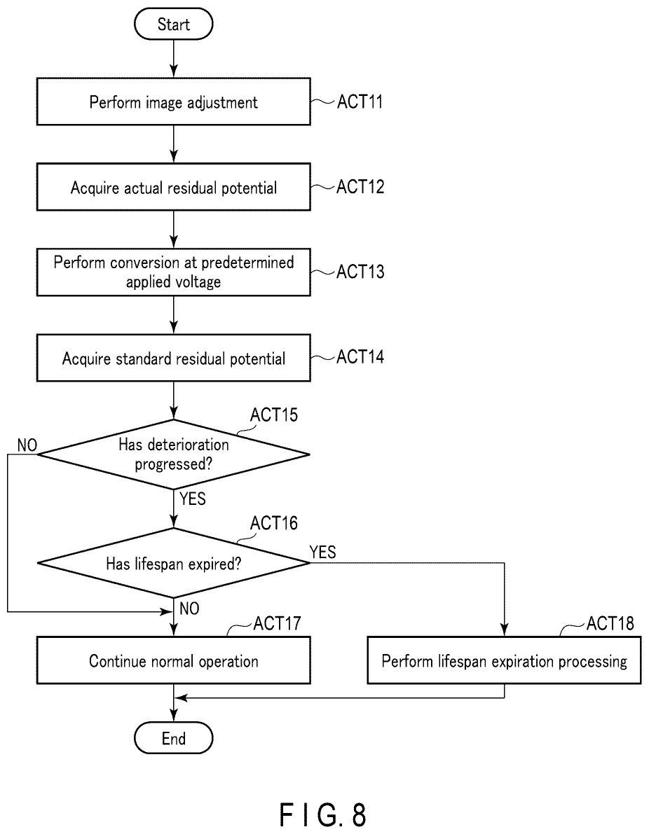

FIG. 8 is a flowchart for describing an example of an operation including the deterioration determination processing of determining whether the photosensitive drum 122 has reached the lifespan in the image forming apparatus 1 according to the embodiment.

Here, the deterioration determination processing illustrated in FIG. 8 is executed in a case where the deterioration index (the number of passed sheets, the drive distance, the drive time, or the like) has not reached a predetermined life setting value. Note that the image forming apparatus 1 may calculate the deterioration index at arbitrary timing. For example, the calculation timing of the deterioration index may be for each print job, may be at the time of executing the image adjustment operation (image quality maintenance control), or may be synchronized with timing of power-on or power-off or wake-up timing from sleep.

The processor 101 of the system controller 5 of the image forming apparatus 1 executes the image adjustment operation including the calculation of the residual potential at predetermined timing set in advance (ACT11). In addition, the processor 101 may execute the image adjustment operation according to an execution instruction of an operator.

Note that the deterioration determination processing may not be performed for each image adjustment operation, and the timing of executing the deterioration determination processing associated with the image adjustment operation may be set. For example, it may be set such that the image adjustment operation is performed every day, and the deterioration determination processing associated with the image adjustment operation is performed every three days.

In the case of executing the deterioration determination processing, the processor 101 of the image forming apparatus 1 acquires the current actual residual potential Ver(b) of the photosensitive drum 122 calculated by the image adjustment operation (ACT12). In a case where the processor 101 has acquired the current actual residual potential Ver(b), the processor 101 converts the acquired actual residual potential Ver(b) into the actual residual potential Ver(b)′ that is a value at a predetermined applied voltage (ACT13). Here, the applied voltage is the charging bias voltage supplied from the charging bias transformer 143 to the charger 126. The processor 101 of the system controller 5 controls the charging bias voltage according to the adjustment of the contrast voltage in the image adjustment operation. Therefore, the processor 101 converts the actual residual potential Ver(b) calculated in the image adjustment operation into the actual residual potential Ver(b)′ at the predetermined applied voltage (for example, 600 V).

In addition, the processor 101 of the image forming apparatus 1 acquires the standard residual potential Ver(a)′ corresponding to the current deterioration index based on the value stored in the preset photosensitive body table (ACT14). For example, the photosensitive body table stores the value indicating the relationship among the applied voltage, the charging potential, and the residual potential in consideration of environmental conditions. The photosensitive body table is stored in the ROM 102 or the storage 104 in the system controller 5. The processor 101 calculates the standard residual potential Ver(a) with respect to the current deterioration index as the standard residual potential Ver(a)′ at the predetermined applied voltage based on the photosensitive body table.

In a case where the processor 101 of the image forming apparatus 1 has acquired the current actual residual potential Ver(b)′ and the standard residual potential Ver(a)′, the processor 101 determines whether or not the deterioration has progressed beyond the assumption (standard) (ACT15). For example, the processor 101 determines whether or not the deterioration of the photosensitive drum 122 has progressed faster than assumed according to a difference between the current actual residual potential Ver(b)′ and the standard residual potential Ver(a)′.

Specifically, in a case of Ver(b)′>Ver(a)′, the processor 101 determines that the deterioration of the photosensitive drum 122 progresses faster than assumed. In addition, since the actual residual potential Ver(b)′ is a value to be actually calculated, there is a possibility that an error or the like is included. Therefore, in a case where Ver(b)′−Ver(a)′ is equal to or greater than a predetermined value, the processor 101 may determine that the deterioration of the photosensitive drum 122 progresses faster than assumed. Furthermore, in a case of Ver(b)′<Ver(a)′, the progress of the processor 101 may determine that the deterioration of the photosensitive drum 122 is slower than assumed.

In a case where the processor 101 of the image forming apparatus 1 determines that the deterioration has progressed (ACT15, YES), the processor 101 determines whether or not the current actual residual potential Ver(b)′ has reached the limit value VT (ACT16). In a case where the current actual residual potential Ver(b)′ has not reached the limit value VT (ACT16, NO), the processor 101 of the image forming apparatus 1 continues the normal operation (ACT17).

In a case where the current actual residual potential Ver(b)′ has reached the limit value VT (ACT16, YES), the processor 101 of the image forming apparatus 1 executes lifespan expiration processing, assuming that the photosensitive drum 122 has reached the lifespan (ACT18). As the lifespan expiration processing, the processor 101 provides notification that the photosensitive drum 122 has reached the lifespan (replacement time).

For example, the processor 101 displays a guide for prompting replacement of the photosensitive drum on the display unit of the operation panel 3. As a result, it is possible to notify the user that the photosensitive drum 122 has reached the lifespan. In addition, the processor 101 notifies the server apparatus 300 that the photosensitive drum 122 of the image forming apparatus 1 has reached the lifespan through the communication I/F 105. As a result, it is possible to notify an administrator, a serviceman, or the like that the photosensitive drum 122 of the image forming apparatus 1 has reached the lifespan.

In addition, the processor 101 may perform control setting for executing a control operation according to a case where the photosensitive drum 122 has reached the lifespan as the lifespan expiration processing. As a result, the processor 101 can continue processing such as printing by control according to the state of the photosensitive drum 122 even in a state where the photosensitive drum 122 has reached the lifespan.

According to the above-described deterioration determination processing, the image forming apparatus according to the embodiment can perform lifespan determination according to the actual state of the photosensitive drum based on the actual residual potential in the photosensitive drum. That is, in a case where the actual residual potential actually calculated in the image adjustment operation is higher than the standard residual potential, the image forming apparatus determines whether or not the actual residual potential has reached the limit value. In the image forming apparatus, it is assumed that the photosensitive drum has reached the lifespan in a case where the actual residual potential has reached the limit value.

As a result, the image forming apparatus can determine whether or not the photosensitive drum has reached the lifespan according to the actual state even before reaching a default set lifespan (standard set lifespan) assigned to the deterioration index. As a result, the image forming apparatus can perform guidance or the like to encourage replacement of the photosensitive drum if the photosensitive drum has reached the lifespan even before the deterioration index reaches the standard set lifespan.

Next, an example of an operation including correction processing of correcting the life setting value for determining the lifespan of the photosensitive drum 122 in the image forming apparatus 1 according to the embodiment will be described.

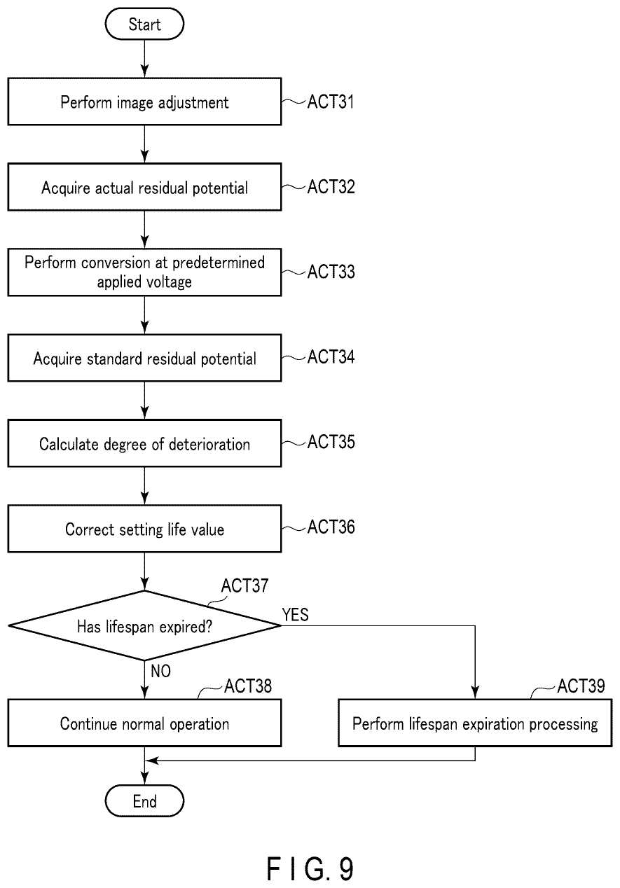

FIG. 9 is a flowchart for describing an example of an operation including the correction processing of correcting the life setting value for determining the lifespan of the photosensitive drum 122 in the image forming apparatus 1 according to the embodiment.

Here, it is assumed that the image forming apparatus 1 calculates the current actual residual potential (actual residual potential) by the image adjustment operation. That is, the processor 101 of the system controller 5 of the image forming apparatus 1 executes the image adjustment operation including the calculation of the residual potential at predetermined timing or according to an execution instruction (ACT31).

The processor 101 of the image forming apparatus 1 acquires the current actual residual potential Ver(b) of the photosensitive drum 122 calculated by the image adjustment operation (ACT32). In the case where the processor 101 has acquired the current actual residual potential Ver(b), the processor 101 converts the acquired actual residual potential Ver(b) into the actual residual potential Ver(b)′ that is the value at the predetermined applied voltage (ACT33).

In addition, the processor 101 acquires the standard residual potential Ver(a)′ at the predetermined applied voltage corresponding to the current deterioration index based on the value stored in the preset photosensitive body table (ACT34).

In the case where the processor 101 of the image forming apparatus 1 has acquired the current actual residual potential Ver(b)′ and the standard residual potential Ver(a)′, the processor 101 calculates a degree of deterioration D indicating the degree of progress of the deterioration of the photosensitive drum 122 (ACT35). Here, the processor 101 calculates the degree of deterioration D indicating the degree of progress of the deterioration of the photosensitive drum 122 based on the standard residual potential. For example, the processor 101 calculates the degree of deterioration D based on a degree of change in the actual residual potential (current value−past value) and a degree of change in the standard residual potential corresponding thereto.

Here, an example of a method of calculating the degree of deterioration D according to the difference between the current actual residual potential and the previous actual residual potential will be described as a first specific example.

As the first specific example, the processor 101 of the image forming apparatus 1 can calculate the degree of deterioration D in the case where the deterioration index is the number of passed sheets P by the following calculation.

The number of passed sheets in a case where the present (current) actual residual potential is calculated: Pi

The number of passed sheets in a case where the previous (past) actual residual potential is calculated: Pi-1

The standard residual potential at the number of passed sheets Pi (at the predetermined applied voltage): Ver(aPi)′

The actual residual potential at the number of passed sheets Pi (at the predetermined applied voltage): Ver(bPi)′

The standard residual potential at the number of passed sheets Pi-1 (at the predetermined applied voltage): Ver(aPi-1)′

The actual residual potential at the number of passed sheets Pi-1 (at the predetermined applied voltage): Ver(bPi-1)′

The degree of deterioration D=[Ver(bPi)′−Ver(bPi-1)′]/[Ver(aPi)−Ver(aPi-1)′].

In addition, as the first specific example, the processor 101 of the image forming apparatus 1 can calculate the degree of deterioration D in a case where the deterioration index is the drive time (a drive counter indicating the drive time) T of the photosensitive drum 122 by the following calculation.

The drive time in a case where the present (current) actual residual potential is calculated: Ti

The drive time in a case where the previous (past) actual residual potential is calculated: Ti-1

The standard residual potential at the drive time Ti (at the predetermined applied voltage): Ver(aTi)′

The actual residual potential at the drive time Ti (at the predetermined applied voltage): Ver(bTi)′

The standard residual potential at the drive time Ti-1 (at the predetermined applied voltage): Ver(aTi-1)′

The actual residual potential at the drive time Ti-1 (at the predetermined applied voltage): Ver(bTi-1)′

The degree of deterioration D=[Ver(bTi)′−Ver(bTi-1)′]/[Ver(aTi)−Ver(aTi-1)′].

Further, in the above-described example, the degree of deterioration D is calculated according to the difference between the current residual potential and the previous residual potential. However, the degree of deterioration D is not limited to being calculated from the difference between the current residual potential and the previous residual potential. The above-described degree of deterioration D can be calculated by using the difference between the current residual potential and the past residual potential. For example, the processor 101 stores the residual potential calculated in setup processing in a case where the photosensitive drum 122 is set in the storage 104 as an initial value of the residual potential. After the setup processing, the processor 101 may calculate the degree of deterioration D according to the difference between the current actual residual potential acquired in the image adjustment operation and the residual potential of the initial value.

Here, an example of a method of calculating the degree of deterioration D according to the difference between the current residual potential and the residual potential of the initial value will be described as a second specific example.

As the second specific example, the processor 101 of the image forming apparatus 1 can calculate the degree of deterioration D in the case where the deterioration index is the number of passed sheets P by the following calculation.

The number of passed sheets in a case where the present (current) actual residual potential is calculated: Pi

The standard residual potential at the number of passed sheets Pi (at the predetermined applied voltage): Ver(aPi)′

The actual residual potential at the number of passed sheets Pi (at the predetermined applied voltage): Ver(bPi)′

The standard residual potential at an initial value P0 of the number of passed sheets (at the predetermined applied voltage): Ver(0)′

The degree of deterioration D=[Ver(bPi)′−Ver(0)′]/[Ver(aPi)−Ver(0)′].

As the second specific example, the processor 101 of the image forming apparatus 1 can calculate the degree of deterioration D in a case where the deterioration index is the drive time T of the photosensitive drum 122 by the following calculation.

The drive time in a case where the present (current) actual residual potential is calculated: Ti

The standard residual potential at the drive time Ti (at the predetermined applied voltage): Ver(aTi)′

The actual residual potential at the drive time Ti (at the predetermined applied voltage): Ver(bTi)′

The standard residual potential at an initial value T0 of the drive time (at the predetermined applied voltage): Ver(0)′

The degree of deterioration D=[Ver(bTi)′−Ver(0)′]/[Ver(aTi)−Ver(0)′].

After calculating the degree of deterioration D, the processor 101 of the image forming apparatus 1 corrects the life setting value according to the calculated degree of deterioration D (ACT36). The life setting value is a value set assuming a value corresponding to the deterioration index in the case where the photosensitive drum 122 reaches the lifespan. For example, in an initial state (standard state), the life setting value is the deterioration index in the case where the standard residual potential becomes the limit value VT. The degree of deterioration D is a value indicating the degree of progress of the deterioration of the photosensitive drum 122 with respect to a standard state. Therefore, by correcting the life setting value according to the degree of deterioration D, it is possible to obtain the life setting value indicating the current lifespan of the photosensitive drum 122.

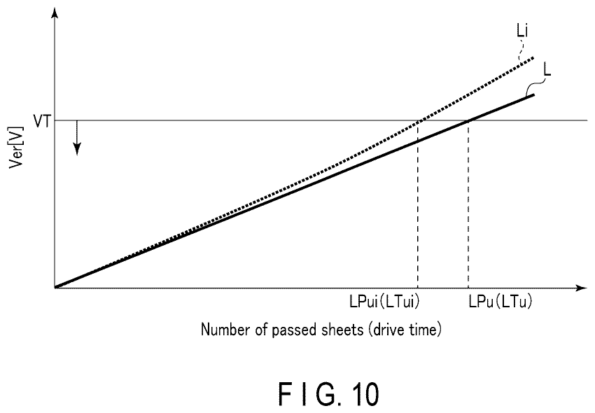

FIG. 10 is a graph illustrating an example of a lifespan curve L indicating the standard life setting value and a corrected lifespan curve Li corrected with the degree of deterioration D.

In the example illustrated in FIG. 10, the corrected lifespan curve Li indicates a corrected lifespan in a case where the degree of progress of the deterioration of the photosensitive drum 122 is faster than the standard. In a case where the progress of the deterioration of the photosensitive drum 122 is faster than the standard, the degree of deterioration D is a value that corrects the lifespan of the photosensitive drum 122 to be faster than the standard lifespan. That is, in the corrected lifespan curve Li, in the case where the deterioration index is the number of passed sheets, the number of passed sheets (corrected lifespan) until the residual potential reaches the predetermined limit value VT is smaller than that of the standard lifespan obtained from the standard lifespan curve L. Further, in the corrected lifespan curve Li, in the case where the deterioration index is the drive time, the drive time (corrected lifespan) until the residual potential reaches the predetermined limit value VT is shorter than that of the standard lifespan.

Here, a specific example of a method in which the image forming apparatus 1 corrects the life setting value using the degree of deterioration D will be described.

In the case where the deterioration index is the number of passed sheets P, the processor 101 of the image forming apparatus 1 can calculate a correction value of the life setting value using the degree of deterioration D (corrected life setting value) by the following calculation.

The standard life setting value for the number of passed sheets: LPu

The corrected life setting value for the number of passed sheets: LPui=LPu/D.

Further, in the case where the deterioration index is the drive time T of the photosensitive drum 122, the processor 101 of the image forming apparatus 1 can calculate the correction value of the life setting value using the degree of deterioration D (corrected life setting value) by the following calculation.

The standard life setting value for the drive time: LTu

The corrected life setting value for the drive time: LTui=LTu/D.

After correcting the life setting value with the degree of deterioration D, the processor 101 of the image forming apparatus 1 determines whether or not the photosensitive drum 122 has reached the lifespan based on the corrected life setting value (ACT37). The processor 101 of the image forming apparatus 1 determines whether or not the photosensitive drum 122 has reached the lifespan based on whether or not the deterioration index is equal to or greater than the corrected life setting value. In a case where the photosensitive drum 122 has not reached the lifespan with the corrected life setting value (ACT37, NO), the processor 101 continues the normal operation (ACT38).

In a case where the photosensitive drum 122 has reached the lifespan with the corrected life setting value (ACT37, YES), the processor 101 of the image forming apparatus 1 executes the lifespan expiration processing (ACT39). As the lifespan expiration processing, the processor 101 provides notification that the photosensitive drum 122 has reached the lifespan (replacement time).

For example, the processor 101 displays a guide for prompting replacement of the photosensitive drum on the display unit of the operation panel 3. In addition, the processor 101 notifies the server apparatus 300 that the photosensitive drum 122 of the image forming apparatus 1 has reached the lifespan through the communication I/F 105. In addition, the processor 101 may perform control setting for executing a control operation according to a case where the photosensitive drum 122 has reached the lifespan as the lifespan expiration processing.

According to the above correction processing, the image forming apparatus according to the embodiment corrects the life setting value for determining the lifespan of the photosensitive drum based on the actual residual potential in the photosensitive drum. That is, the image forming apparatus corrects the standard life setting value based on the degree of change in the actual residual potential actually calculated in the image adjustment operation based on the standard residual potential. Specifically, the image forming apparatus corrects the life setting value according to the degree of deterioration calculated from the degree of change in the actual residual potential actually calculated in the image adjustment operation (the difference between the current actual residual potential and the past residual potential) and the degree of change in the standard residual potential (the difference between the current standard residual potential and the past standard residual potential).

As a result, the image forming apparatus can correct the default set lifespan (standard set lifespan) assigned to the deterioration index according to the progress of the deterioration in the actual photosensitive drum. That is, the image forming apparatus feeds back the actual degree of deterioration of the photosensitive drum to the life setting value, thereby determining whether or not the photosensitive drum has reached the lifespan according to the actual state of the photosensitive drum. As a result, the image forming apparatus can detect that the deterioration index has reached the lifespan according to the actual state, and can perform guidance or the like to encourage replacement of the photosensitive drum even before the deterioration index reaches the standard set lifespan.

Next, an example of an operation including advance notification processing according to lifespan expiration prediction of the photosensitive drum 122 in the image forming apparatus 1 according to the embodiment will be described.

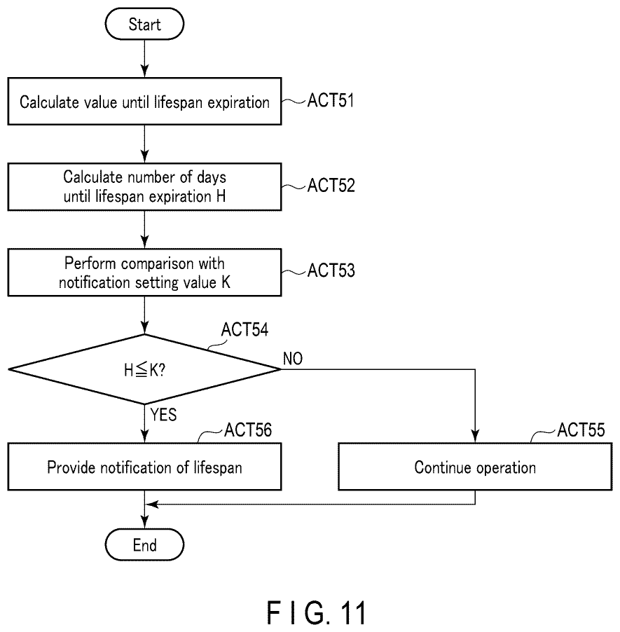

FIG. 11 is a flowchart for describing an example of an operation including the advance notification processing based on the lifespan expiration prediction of the photosensitive drum 122 in the image forming apparatus 1 according to the embodiment.

The advance notification processing illustrated in FIG. 11 can be performed at arbitrary timing. For example, the advance notification processing may be performed at predetermined timing (every day or every week), or may be performed in a case where the life setting value is corrected by the above-described processing.

In the case of executing the advance notification processing, the processor 101 of the image forming apparatus 1 calculates the value of the deterioration index (the deterioration index corresponding to the life setting value) until the lifespan expiration (ACT51). For example, in the case where the deterioration index is the number of passed sheets, the processor 101 calculates a value obtained by subtracting the current number of passed sheets from the number of passed sheets (the number of passed sheets when the residual potential reaches the limit value) set as the life setting value. As a specific example, the number of passed sheets until the lifespan expiration is “LPui−Pi” by the corrected life setting value (LPui) and the current number of passed sheets (Pi).

After calculating the value of the deterioration index until the lifespan expiration, the processor 101 calculates a remaining number of days until the lifespan expiration (ACT52). For example, in the case where the deterioration index is the number of passed sheets, a remaining number of days until the lifespan expiration H can be calculated by dividing the number of passed sheets (LPui−Pi) until the lifespan expiration by the number of passed sheets (predicted value) for one day.

As a specific example, it is assumed that the image forming apparatus 1 can grasp a monthly average number of passed sheets (printing number) MDL and monthly operating days. In this case, a remaining number of months until the lifespan expiration can be calculated by dividing the number of passed sheets (LPui−Pi) until the lifespan expiration by a monthly average number of passed sheets MDL. Therefore, the remaining number of days until the lifespan expiration may be calculated by the following calculation expression. The remaining number of days until the lifespan expiration H=(LPui−Pi)/[MDV/(the monthly operating days)].

After calculating the remaining number of days until the lifespan expiration H, the processor 101 compares the remaining number of days until the lifespan expiration with the remaining number of days K of the notification setting value (ACT53). In a case where the remaining number of days until the lifespan expiration H is larger than the number of remaining days K of the notification setting value (ACT54, YES), the processor 101 continues the operation without performing advance notification (ACT55). In a case where the number of remaining days until the lifespan expiration H is equal to or less than the number of remaining days K of the notification setting value (ACT54, YES), the processor 101 performs the advance notification to provide notification of the remaining number of days until the lifespan expiration or the like (ACT56).

According to the above-described advance notification processing, the image forming apparatus can predict the time until the photosensitive drum reaches the lifespan according to the life setting value corrected in accordance with the actual deterioration state. In addition, the image forming apparatus can notify the user or the administrator of the lifespan of the photosensitive drum before the state of the photosensitive drum reaches the actual lifespan.

As described above, the image forming apparatus according to the embodiment can perform the lifespan determination according to the deterioration state of the photosensitive drum without adding a detection device for determining the lifespan of the photosensitive drum. In addition, the image forming apparatus according to the embodiment can appropriately provide notification of the lifespan of the photosensitive drum even in a state where the lifespan of the photosensitive drum becomes shorter than the standard set lifespan due to the progress of deterioration beyond assumption.

As a result, the image forming apparatus according to the embodiment can prevent failure of a main body of the image forming apparatus due to continuous use of the photosensitive drum that has reached the lifespan for a long period of time. In addition, the image forming apparatus according to the embodiment can promote replacement of the photosensitive drum at appropriate timing. Furthermore, since the image forming apparatus according to the embodiment can correct the standard set lifespan according to the actual state of the photosensitive drum, it is also possible to use the life setting value for a long time in a case where the progress of deterioration is slower than the standard.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a photosensitive body on which an electrostatic latent image is formed by light applied to a uniformly charged surface;
a developing unit configured to develop the electrostatic latent image formed on the photosensitive body;
a storage unit configured to store a life setting value for determining that the photosensitive body has reached a lifespan; and
a processor configured to correct the life setting value stored in the storage unit according to an actual residual potential in the photosensitive body.

2. The image forming apparatus according to claim 1, wherein
the processor is configured to correct the life setting value stored in the storage unit according to the actual residual potential and a standard residual potential in the photosensitive body.

3. The image forming apparatus according to claim 2, wherein
the processor is configured to correct the life setting value according to a degree of deterioration calculated from the actual residual potential and the standard residual potential in the photosensitive body.

4. The image forming apparatus according to claim 3, wherein
the processor is configured to calculate the degree of deterioration based on a first difference between the current actual residual potential and the actual residual potential at a past time point and a second difference between the current standard residual potential and the standard residual potential at the past time point.

5. The image forming apparatus according to claim 4, wherein
the processor is configured to calculate a ratio between the first difference and the second difference as the degree of deterioration, and correct the life setting value according to the ratio.

6. The image forming apparatus according to claim 3, wherein
the processor is configured to calculate the degree of deterioration based on a first difference between the current actual residual potential and an initial value of a residual potential and a second difference between the current standard residual potential and the initial value of the residual potential.

7. The image forming apparatus according to claim 6, wherein
the processor is configured to calculate a ratio between the first difference and the second difference as the degree of deterioration, and correct the life setting value according to the ratio.

8. The image forming apparatus according to claim 1, wherein,
in a case where the processor has corrected the life setting value, the processor is configured to provide notification of a remaining number of days until the photosensitive body reaches the lifespan calculated based on the corrected life setting value.

9. The image forming apparatus according to claim 1, wherein
the storage unit is configured to store a notification setting value including a setting of a remaining number of days to provide notification of the lifespan of the photosensitive body in advance, and
in a case where the remaining number of days until the photosensitive body reaches the lifespan reaches the remaining number of days of the notification setting value, the processor is configured to provide notification of the remaining number of days until the photosensitive body reaches the lifespan.

10. A non-transitory storage medium storing a program causing a processor that controls an image forming apparatus to implement:
acquiring a current residual potential in a photosensitive body on which an electrostatic latent image is formed as an actual residual potential;
acquiring a residual potential calculated from a photosensitive body coefficient of the photosensitive body as a standard residual potential; and
correcting a life setting value for the photosensitive body stored in a storage unit according to the actual residual potential and the standard residual potential.

11. The non-transitory storage medium according to claim 10, wherein
the program causes the processor to execute correcting the life setting value according to a degree of deterioration calculated from the actual residual potential and the standard residual potential in the photosensitive body.

12. A storage medium storing the program according to claim 11, wherein
the program causes the processor to execute calculating the degree of deterioration based on a first difference between the current actual residual potential and the actual residual potential at a past time point and a second difference between the current standard residual potential and the standard residual potential at the past time point.

13. A non-transitory storage medium according to claim 12, wherein
the program causes the processor to execute calculating a ratio between the first difference and the second difference as the degree of deterioration, and correcting the life setting value according to the ratio.

14. The non-transitory storage medium according to claim 11, wherein
the program causes the processor to execute calculating the degree of deterioration based on a first difference between the current actual residual potential and an initial value of a residual potential and a second difference between the current standard residual potential and the initial value of the residual potential.

15. The non-transitory storage medium according to claim 14, wherein
the program causes the processor to execute calculating a ratio between the first difference and the second difference as the degree of deterioration, and correcting the life setting value according to the ratio.

16. A nonvolatile storage medium storing the program according to claim 10, wherein,
in a case where the processor has corrected the life setting value, the processor is caused to execute providing notification of a remaining number of days until the photosensitive body reaches a lifespan calculated based on the corrected life setting value.

17. The non-transitory storage medium according to claim 10, wherein
the program causes the processor to execute storing, in the storage unit, a notification setting value including a setting of a remaining number of days to provide notification of a lifespan of the photosensitive body in advance, and
in a case where the remaining number of days until the photosensitive body reaches the lifespan reaches the remaining number of days of the notification setting value, providing notification of the remaining number of days until the photosensitive body reaches the lifespan.

18. A method of setting a life of a photosensitive body in an image forming apparatus, the method comprising:
acquiring a current residual potential in the photosensitive body as an actual residual potential;
acquiring a residual potential calculated from a photosensitive body coefficient of the photosensitive body as a standard residual potential; and
correcting a life setting value for the photosensitive body stored in a storage unit according to the actual residual potential and the standard residual potential, and providing notification of information regarding a lifespan based on the corrected life setting value.

19. The method of setting a life of a photosensitive body in an image forming apparatus according to claim 18, the method further comprising:
in a case of having corrected the life setting value, providing notification of a remaining number of days until the photosensitive body reaches the lifespan calculated based on the corrected life setting value.

20. The method of setting a life in a photosensitive body in an image forming apparatus according to claim 18, wherein
the program stores, in the storage unit, a notification setting value including a setting of a remaining number of days to provide notification of the lifespan of the photosensitive body in advance, and
in a case where the remaining number of days until the photosensitive body reaches the lifespan reaches the remaining number of days of the notification setting value, providing notification of the remaining number of days until the photosensitive body reaches the lifespan.
